(19) United States
(12) Patent Application Publication
(10) Pub. No.: US 2013/0031746 A1
(43) Pub. Date: Feb. 7, 2013

(54) DOOR OPENING AND CLOSING DEVICE

(71) Applicants: Manabu Hasegawa, Tokyo (JP); Masaya Suzuki, Tokyo (JP)

(72) Inventors: Manabu Hasegawa, Tokyo (JP); Masaya Suzuki, Tokyo (JP)

(73) Assignee: SUGATSUNE KOGYO CO., LTD, Tokyo (JP)

(21) Appl. No.: 13/641,157

(22) PCT Filed: Feb. 28, 2011
(86) PCT No.: PCT/JP2011/054453

§ 371 Date: Oct. 15, 2012

(30) Foreign Application Priority Data
Apr. 16, 2010 (JP) 2010-094715

(51) Int. Cl. E05F 3/20

(52) U.S. Cl. 16/50

(57) ABSTRACT

A door opening and closing device can change a damping force of a damper when an arm rotates by opening and closing of a door. On a case 11 of the door opening and closing device 7, the arm 8 is mounted which rotates by opening and closing of the door 2. Inside the case 11, friction generating unit 22 is provided. The friction generating unit 22 has a slider 12d which moves linearly relative to the case 11 by opening and closing of the door 2 and a fixed part 21 which is fixed to the case 11 to slide the slider 12d. The friction generating unit 22 generates friction between the slider 12d and the fixed part 21. In opening and closing of the door 2, a radio of the rotation angle of the arm 8 and the amount of displacement of the slider 12d is varied.

### TECHNICAL FIELD

The present invention relates to a door opening and closing device, provided between a door and a door mounting member such as a cabinet, for enabling smooth opening and closing operations of the door.

### BACKGROUND ART

The door opening and closing device mounted on the door has the function of enabling the manual opening operation of the door easily and by a small force with use of a biasing force of a compression spring and the function of slowing the opening and closing operations of the door by a damping force of a damper (see PL1).

Such a door opening and closing device has an arm which rotates by opening and closing operations of the door and a runner that is biased by a compression spring to give a biasing force in the opening or closing direction to the arm. The arm and the runner are connected to each other by a link arm which synchronizes rotation of the arm with linear movement of the runner. An end of the link arm is rotatably connected to the runner and the other end of the link arm is rotatably connected to the periphery of the rotation center of the arm. With use of an elastic force of the compression spring, the opening and closing operations of the door can be performed easily by a small force.

The door opening and closing device is provided with a damper for slowing the opening and closing operations of the door. As the damper is used to brake the opening or closing operation of the door based on the elastic force of the compression spring, the door can open and close slowly.

The patent literature 1 (PL1) discloses a door opening and closing device in which a rotary damper is used as the above-mentioned damper and is mounted on the rotation axis of the arm. A one-way clutch may be built in the rotary damper thereby to generate a damping force only in opening or closing of the door.

The patent literature 2 (PL2) discloses an example of using a linear damper. There is provided a neutral range between the opening position and the closing position of the arm, in which range the damping force of the damper is not available. The damping force is set to be generated just before the opening position and closing position of the arm.

### CITATION LIST

### Patent Literature

PL1: Japanese Patent No. 3300981
PL2: Japanese Patent Application Laid-Open No. 2007-522363

### SUMMARY OF INVENTION

### Technical Problem

However, in the door opening and closing device disclosed in the patent literature 1, the rotary damper generates a fixed damping force while the arm rotates from the closing position to the opening position. Therefore, for example, it is difficult to reduce the damping force when the arm is near the closing position and to increase the damping force when the arm is near the opening position. In order to facilitate the opening direction of the door, it is requested to reduce the damping force when the arm is near the closing position.

In the door opening and closing device disclosed in the patent literature 2, the neutral range where the damping force of the damper is not available is provided between the opening position and the closing position of the arm. However, once the damping force is generated, its size or magnitude does not change. Therefore, it is difficult to vary or adjust the damping force in accordance with the degree of opening and closing of the arm.

Then, the present invention aims to provide a door opening and closing device capable of changing a damping force of the damper when the arm rotates by opening and closing of the door.

### Solution to Problem

In order to solve the above-mentioned problems, a first aspect of the present invention is a door opening and closing device comprising: a case mounted on a door mounting member; an arm which is provided rotatable on the case and rotates by opening and closing of a door; biasing means for applying at least one of a biasing force in an opening direction and a biasing force in a closing direction to the arm; and friction generating means having a slider which moves linearly relative to the case by opening and closing of the door and a fixed part which is fixed to the case to slide the sider, the friction generating means being provide for generating friction between the slider and the fixed part.

### Advantageous Effects of Invention

According to the present invention, the friction generating means for generating friction between the slider and the fixed part is used to change a ratio of the rotation angle of the arm and the amount of displacement of the slider. With this structure, it is possible to change the damping force of the friction generating means when the arm rotates by opening and closing of the door. Therefore, it is possible to obtain an appropriate damping force in accordance with the degree of opening and closing of the door.

### BRIEF DESCRIPTION OF DRAWINGS

The above and other objects and features of the invention will appear more fully hereinafter from a consideration of the following description taken in connection with the accompanying drawing wherein one example is illustrated by way of example, in which;

FIG. 1 is a vertical cross sectional view of a door-equipped cabinet (a door is closed);

FIG. 2 is a vertical cross sectional view of the door-equipped cabinet (the door is open);

FIG. 3 is a perspective view of the door-equipped cabinet (the door is open);

FIG. 4 is an assembly view of a door opening and closing device according to a first embodiment of the present invention (the door is open);

FIG. 5 is an assembly view of the door opening and closing device (the door is closed);

FIG. 6 is an exploded perspective view of the door opening and closing device;

FIGS. 7(a) to 7(c) are views illustrating the door opening and closing device with or without a cover (FIG. 7(a) is a front view of the door opening and closing device with the cover, FIG. 7(b) is a front view of the door opening and closing device without cover and FIG. 7(c) is a back view of the door opening and closing device without cover);

FIGS. 8(a) to 8(h) are plan views of the door opening and closing device in which the arm rotates by 10 degrees (FIG. 8(a) illustrates the door closed, and FIGS. 8(b) to 8(h) illustrate the arm rotating by 10 degrees. FIG. 8(h) illustrates the door open);

FIG. 9 is an exploded view of an arm, an auxiliary arm and a part of a connecting part (mounting member);

FIG. 10 is an exploded view of a door side mounting part;

FIGS. 11(a) to 11(e) are plan views illustrating connection of the mounting member and the door side mounting part (FIG. 11(a) is a plan view of the mounting member and the door side mounting part which are not yet connected to each other, FIGS. 11(b) to 11(e) are plan views of the connecting process, and FIG. 11(e) is a plan view of the mounting member and the door side mounting part which are completely connected to each other);

FIG. 12 is a plan view of the door opening and closing device according to a second embodiment of the present invention (the door is open);

FIGS. 13(a) to 13(h) are plan views of the door opening and closing device in which the arm rotates by 10 degrees (FIG. 13(a) illustrates the door closed, and FIGS. 13(b) to 13(h) illustrate the arm rotating by 10 degrees. FIG. 13(h) illustrates the door open);

FIG. 14 is a perspective view of the door opening and closing device according to a third embodiment of the present invention;

FIG. 15 is an exploded perspective view of a friction damper; and

FIGS. 16(a) and 16(b) are cross sectional views of the door opening and closing device with the friction damper mounted on.

### DESCRIPTION OF EMBODIMENTS

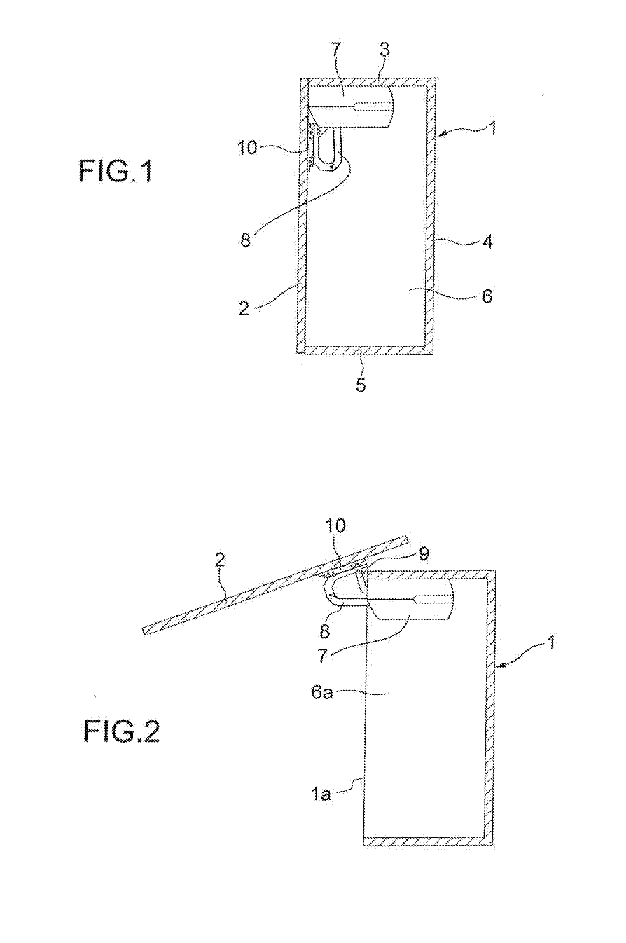

With reference to the attached drawings, description will be made about embodiments of the present invention. FIG. 1 is a vertical cross sectional view of a door-equipped cabinet on which the door opening and closing device according to the first embodiment of the present invention is mounted (a door is closed). FIG. 2 is a vertical cross sectional view of the door-equipped cabinet (the door is open).

A door mounting member 1 has a top plate 3, a back plate 4, a bottom plate 5 and a pair of side plates 6. The door opening and closing device 7 is fixed to a side plate inner wall 6a of the door mounting member 1. On the door opening and closing device 7, a door 2 such as a trap door is mounted via a connecting part 10 mounted on an arm 8 and an auxiliary arm 9. When the arm 8 and the auxiliary arm 9 rotate, the door 2 opens or closes vertically so that an opening part la of the door mounting member 1 is closed or opened. The typical door 2 is connected to the door mounting member 1 via a hinge which makes the door 2 rotatable, however, if the door opening and closing device 7 is provided, the hinge is not required.

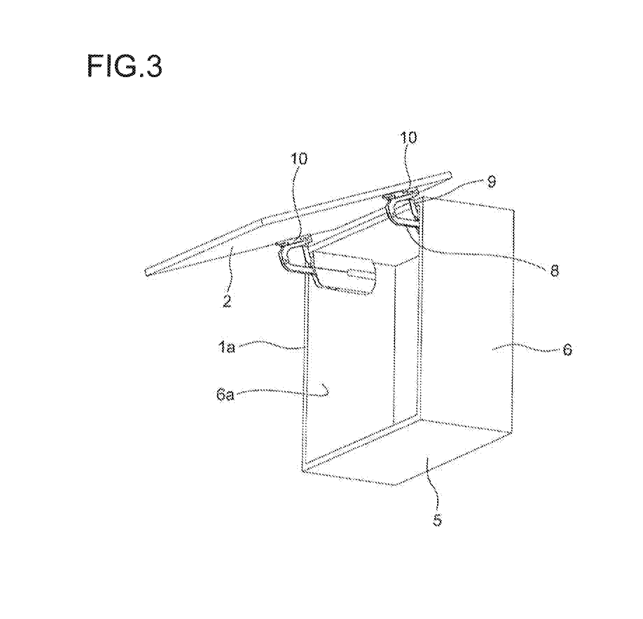

FIG. 3 is a perspective view of the door-equipped cabinet (the door is open). The door opening and closing devices 7 in a pair are fixed to the side plate inner wall 6a on the respective side of the door mounting member 1 and also mounted on the door 2 via the two connecting parts 10. Therefore, the door 2 is prevented from being twisted relative to the door mounting member 1 and stable opening and closing operation is allowed.

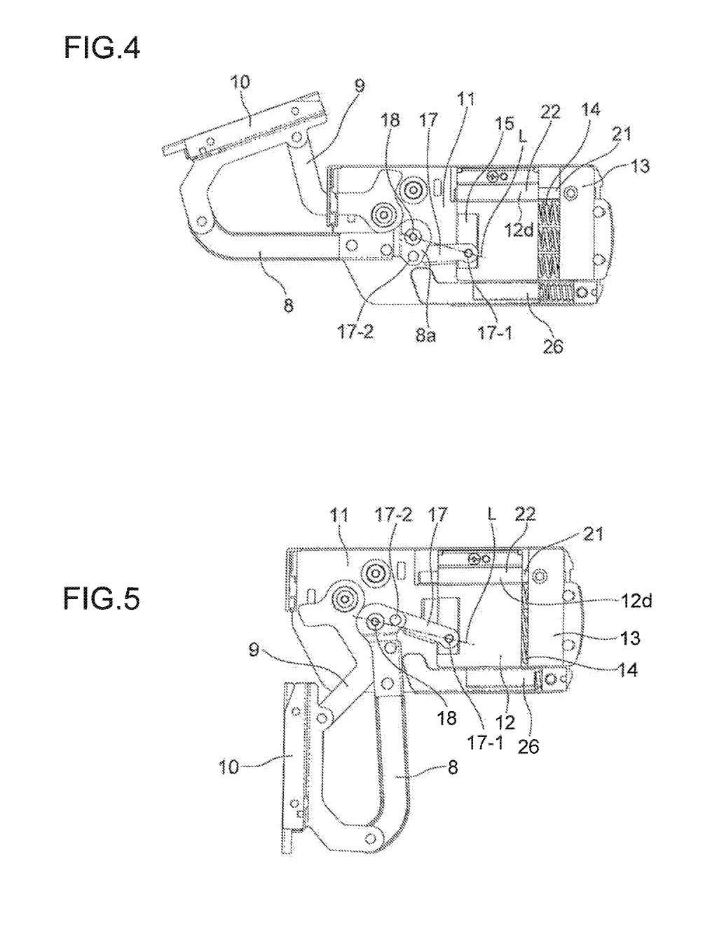

FIG. 4 illustrates the door opening and closing device 7 according to the first embodiment of the present invention (the door is open) and FIG. 5 illustrates the door opening and closing device 7 (the door is closed). On the side plate inner wall 6a of the door mounting member 1, a case 11 is mounted. The arm 8 and the auxiliary arm 9 are connected to the case 11 rotatably. The connecting part 10 is connected to the arm 8 and the auxiliary arm 9 rotatably. These case 11, arm 8, auxiliary arm 9 and connecting part 10 form a four-link mechanism.

When the door 2 is opened or closed manually, the arm 8 and the auxiliary arm 9 rotate from the closed-a position of FIG. 5 to the open position of FIG. 4. A runner 12 is linearly movable relative to the case 11 in the left and right directions of FIG. 4. The runner 12 is connected to an end of a link arm 17 rotatably. The other end of the link arm 17 is connected to the arm 8 rotatably around an arm axis 18 which is a rotation center of the arm 8. The link arm 17 converts rotational movement of the arm 8 into linear movement of the runner 12.

The line connecting the rotation center 17-1 of the link arm 17 relative to the runner 12 to the arm axis 18 is a change line L. As illustrated in FIG. 5, when the door 2 is closed, the rotation center 17-2 of the link arm 17 relative to the arm 8 is positioned above the change line L and the runner 12 gives the arm 8 a biasing force in the closing direction so as to maintain the door 2 closed. When the door 2 is rotated in the opening direction manually, the rotation center 17-2 of the link arm 17 moves below the change line L. Then, the runner 12 gives the arm 8 a biasing force in the opening direction. As illustrated in FIG. 4, when the door 2 is opened, the runner 12 gives the biasing force in the opening direction to the arm 8. With this structure, the door 2 is maintained in the open state.

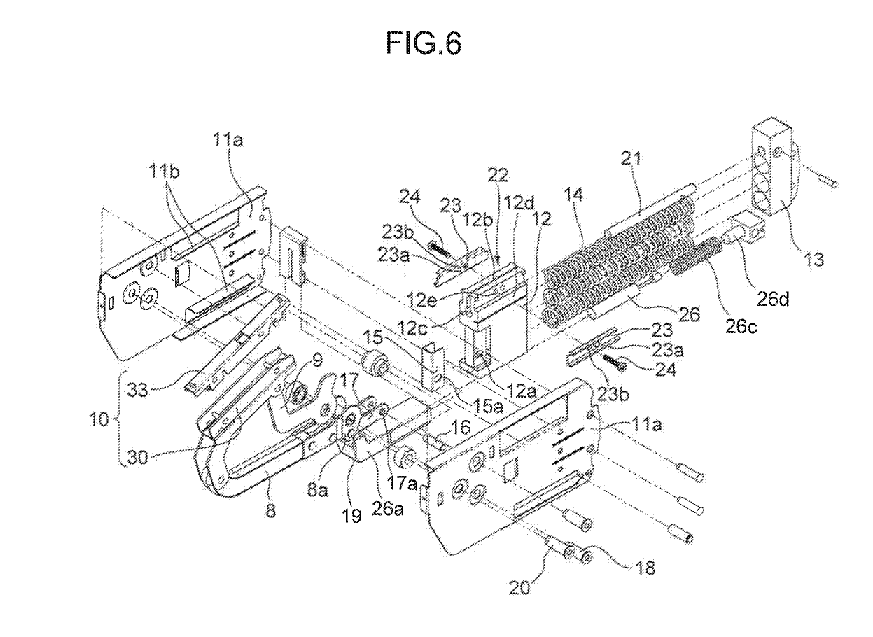

Above the runner 12, a friction damper 22 is provided as friction generating means for attenuating the impact when the door 2 gets open. The friction damper 22 has a block 12d as a slider and a friction bar 21 as a fixed part which is fixed to the case 11. The block 12d has a through hole 12c (see FIG. 6) through which the friction bar 21 passes. When the door 2 opens or closes, the block 12d moves linearly relative to the case 11. When the block 12d moves linearly relative to the case 11, the block 12d slides the friction bar 21 thereby to generate friction between the block 12d and the friction bar 21.

Below the runner 12, a linear damper 26 is provided for attenuating the impact when the door 2 gets closed. The linear damper 26 may be a publicly known linear damper having a cylinder filled with viscous fluid and an extendable rod.

FIG. 6 is an exploded perspective view of the door opening and closing device 7. The case 11 is divided into right and left split cases 11a. In the case 11, the runner 12 is housed linearly movable. In the case 11, a guide wall 11b is formed for guiding linear movement of the runner 12. At the right end of the case 11 in FIG. 6, a stopper 13 is fixed, and at least one (three in FIG. 6) compression spring 14 is provided as biasing member. The compression spring 14 is provided between the runner 12 and the stopper 13. The runner 12 is biased to the left in FIG. 6 by the compression spring 4.

At the left end of the runner 12, a reinforcement plate 15 is provided. The runner 12 and the reinforcement plate 15 have axis pin holes 12a and 15a formed therethrough, respectively. In the axis pin holes 12a and 15a, an axis pin 16 passes through. The axis pin 16 also passes through the axis pin hole 17a at one end of the link arm 17 so that the link arm 17 is rotatable relative to the runner 12.

In the case 11, the arm axis 18 (see FIG. 4) is fixed to the left side of the runner 12. A rotation base 8a of the arm 8 is made rotatable by the arm axis 18. A pivot pin 19 passes through around the arm axis 18 at the rotation base 8a of the arm 8 and the link arm 17 is connected to the pivot pin 19 rotatably.

The arm 8 is formed jutting from the rotation base 8a and the connecting part 10 to connect to the door 2 is provided at the tip end of the arm 8. In the case 11, an auxiliary arm axis 20 is fixed near the arm axis 18 and the auxiliary arm axis 20 is connected rotatably to the auxiliary arm 9. At the tip end of the auxiliary arm 9, the connecting part 10 to connect to the door 2 is provided. The connecting part 10 is connected rotatably to the arm 8 and the auxiliary arm 9.

On the runner 12, the block 12d is provided integrally. The runner 12 and the block 12d4 may be formed integral with each other by resin molding or connected by a fastening member like a screw. In the block 12d, a through hole 12c is formed extending in the moving direction of the runner 12. In the block 12d, a slit 12b is formed extending in parallel with the through hole 12c and communicating to the through hole 12c. In the through hole 12c, the friction bar 21 in parallel with the moving direction of the runner 12 passes therethrough and an end of the friction bar 21 is fixed to the stopper 13.

Next description is made about the adjustment method of the friction force of the friction damper 22. At both, right and left, ends of the block 12d, respective friction plates 23 are provided in a pair. Each friction plate 23 has one adjustment screw hole 23a and one adjustment through hole 23b formed therein. An adjustment bolt 24 is made to pass from each side of the slit 12b through the adjustment through hole 23b of the friction plate 23 and the adjustment hole 12e of the block 12d and is tightened in the adjustment screw hole 23a of the opposite friction plate 23. By the tightening force of the adjustment bolt 24, the block 12d is easily deformed elastically thereby to change the width of the slit 12b. This changes the size of the through hole 12c, thereby adjusting the tightening force between the friction bar 21 and the through hole 12c.

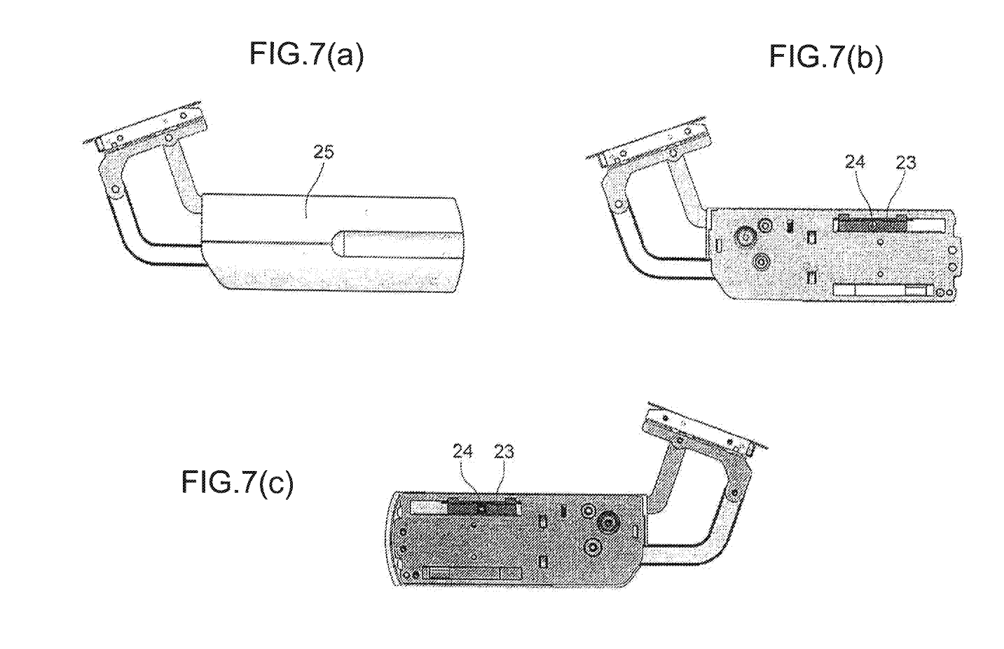

FIG. 7(a) is a front view of the door opening and closing device 7 with a cover 25, FIG. 7(b) is a front view of the door opening and closing device 7 from which the cover 25 is removed and FIG. 7(c) is a back view of the door opening and closing device 7 from which the cover 25 is removed. As the adjustment bolts 24 are tightened from the two directions, that is, the front direction of FIG. 7(b) and the back direction of FIG. 7(c), they can be tightened and loosened from both of the front side and the back side.

When the block 12d moves linearly, there is produced a friction force between the through hole 12c and the friction bar 21 thereby to brake the linear movement of the block 12d. As the block 12d of the friction damper 22 is integral with the runner 12, the friction force generated by differential motion of the friction bar 21 and the block 12d directly acts on the runner 12. Therefore, it is not necessary to provide a separate mechanism for moving the block 12d linearly and the number of components can be reduced.

As illustrated in FIG. 6, the linear damper 26 is housed in a damper body 26a. An end of the linear damper 26 abuts to a damper receiver 26d fixed to the case 11. A damper spring 26c is wound around the linear damper 26. The damper spring 26c is provided for increasing the damping force and is provided between the damper body 26a and the damper receiver 26d.

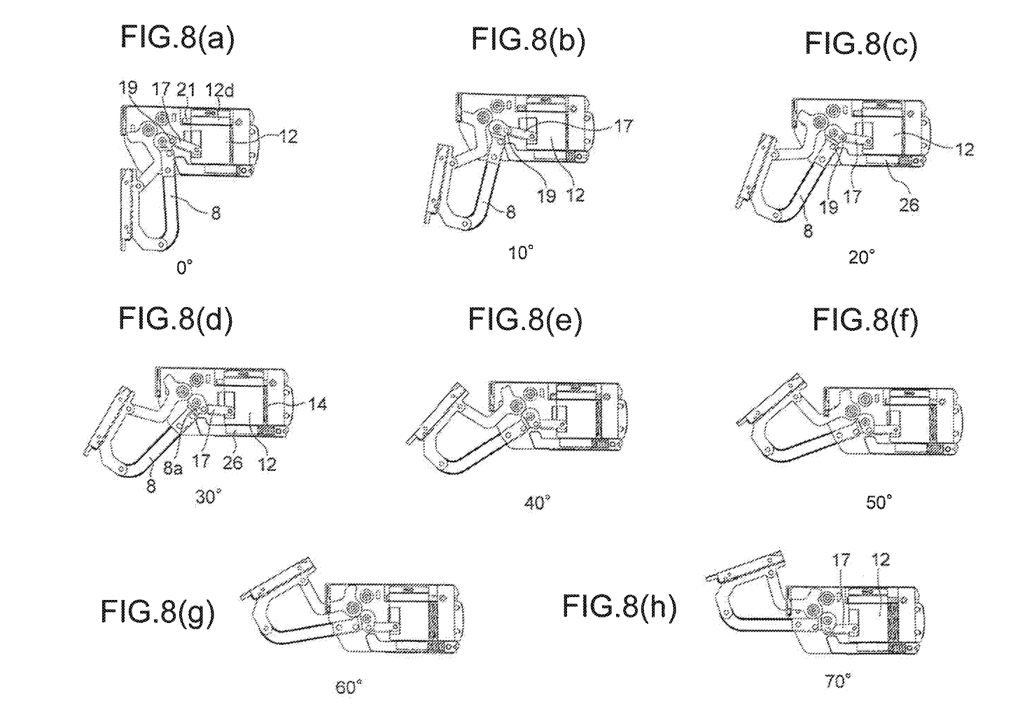

Next description is made, with reference to FIGS. 8(a) to 8(h), about the relation between the rotational movement of the arm 8 by opening and closing of the door 2 and the linear movement of the runner 12 (block 12d) in synchronization with the rotational movement of the arm 8. The rotational movement of the arm 8 is converted to the linear movement of the runner 12 by the link arm 17.

FIG. 8(a) illustrates the door opening and closing device 7 when the door 2 is closed and the rotation angle of the arm 8 is 0 degree. FIG. 8(b) illustrates the door opening and closing device 7 when the arm 8 rotates 10 degrees in the opening direction, and FIGS. 8(c) to 8(h) also illustrate the door opening and closing device 7 as the arm 8 rotates by 10 degrees in the opening direction. FIG. 8(h) illustrates the door opening and closing device 7 when the door 2 is opened completely.

As illustrated in FIGS. 8(a) to 8(c), when the rotation angle of the arm 8 is changed from 0 to 20 degrees, the pivot pin 19 moves mainly downward and therefore, the link arm 17 is rotated by the axis pin 16 but the runner 12 almost moves linearly. Therefore, there occurs almost no differential motion of the block 12d relative to the friction bar 21, and it is possible to open the door 2 by a small force until the arm 8 rotates up to 20 degrees.

FIG. 8(d) illustrates the door opening and closing device 7 when the arm 8 rotates 30 degrees. When the rotation angle of the arm 7 exceeds 30 degrees, the force of the compression spring 14 to bias the arm 8 in the opening direction becomes increased so that the door 2 can open automatically. On the other hand, as the differential motion of the block 12d relative to the friction bar 21 also increases, the damping force acts on the runner 12, and thereby, it is possible to prevent quick linear movement of the runner 12.

FIG. 8(h) illustrates the door opening and closing device 7 when the door 2 is open. Immediately before the door 2 gets open, the force of the compression spring 14 to bias the arm 8 is further increased. However, the differential motion of the block 12d relative to the friction bar 21 is further increased, and the damping force from the friction bar 21 is also further increased. Therefore, the impact when the door gets open is attenuated.

In this way, as the ratio of the rotation angle of the arm 8 and the amount of displacement of the runner 12 is changed, it is possible to reduce the damping force of the friction damper 22 when the rotation angle of the arm 8 is small and to increase the damping force of the friction damper 22 when the rotation angle of the arm 8 is large. Therefore, it is possible to obtain an appropriate damping force in accordance with the degree of opening and closing of the arm 8.

Next, the closing process of the door 2 is described with reference to FIGS. 8(a) to 8(h). Opposite to the opening operation, the door 2 starts to close from the open state of FIG. 8(h) and the arm 8 is rotated. Then, the compression spring 14 is compressed via the runner 12 and the link arm 17. As the door 2 is flipped up at the high position, the torque which acts on the arm 8 is large due to the weight of the door 2 and the compression spring 14 can be easily compressed manually.

As illustrated in FIG. 8(d), when the rotation angle of the arm 8 is 30 degrees, the rotation base 8a of the arm 8 starts to be in contact with the damper body 26a provided below the runner 12. FIG. 8(c) illustrates the door opening and closing device 7 when the door 2 is further rotated in the closing direction. The rotation angle of the arm 8 becomes small and the damping force of the friction damper 22 is reduced. However, as the linear damper 26 operates, the closing direction of the door 2 becomes slow.

Next description is made about the structure and operation of the connecting part 10.

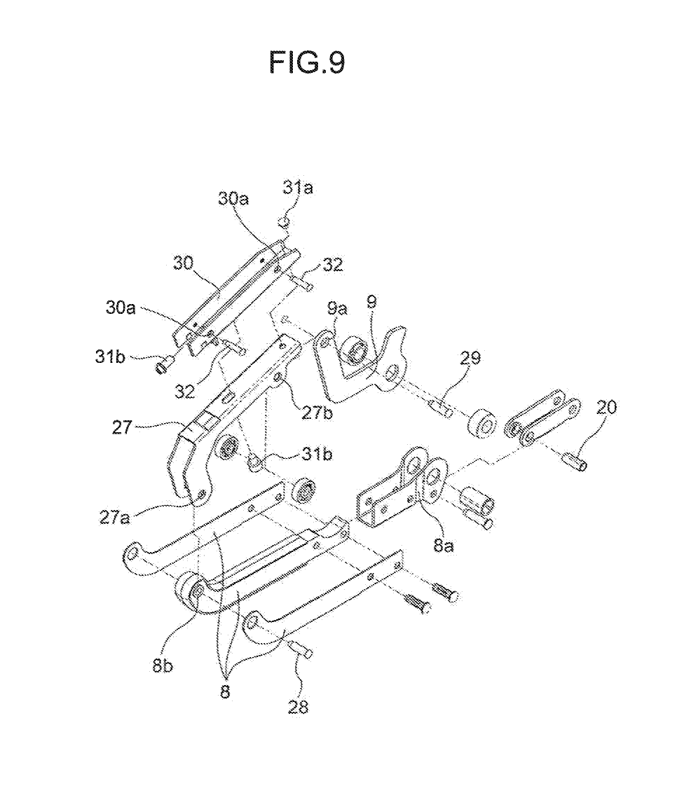

FIG. 9 is an exploded view of the arm 8, the auxiliary arm 9 and a part of the connecting part 10. The arm 8 has a mounting pin hole 8b formed at the tip end opposite to the rotation base 8a. The auxiliary arm 9 has an auxiliary mounting pin hole 9a formed at the tip end opposite to the auxiliary arm axis 20. At both ends of a mounting plate 27, mounting holes 27a and 27b are formed so that a plate mounting pin 28 and an auxiliary mounting pin 29 pass through the mounting holes 27a and 27b. The mounting plate 27 is pivoted on the tip ends of the arm 8 and auxiliary arm 9 opposite to the runner 12. The mounting plate 27 is rotatable by the plate mounting pin 28 and the auxiliary mounting pin 29. To the mounting plate 27, a mounting member 30 is fixed by fixing pins 31a and 31b. At both ends of the mounting member 30, stepped pin holes 30a are formed for insertion of stepped pins 32.

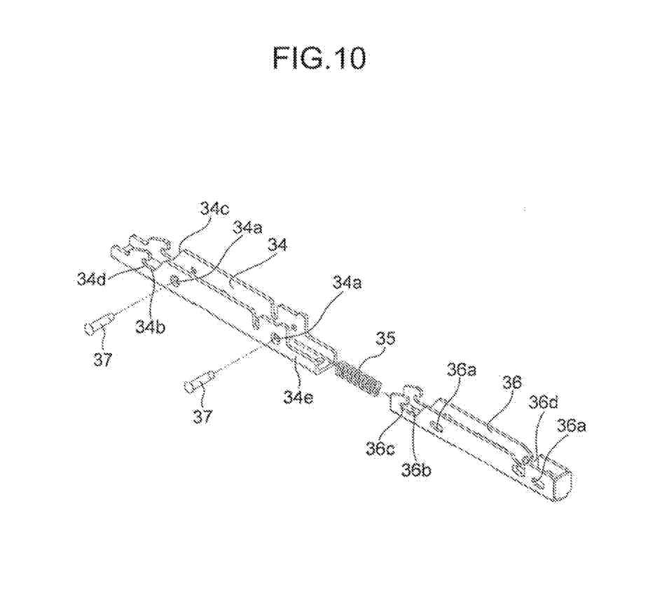

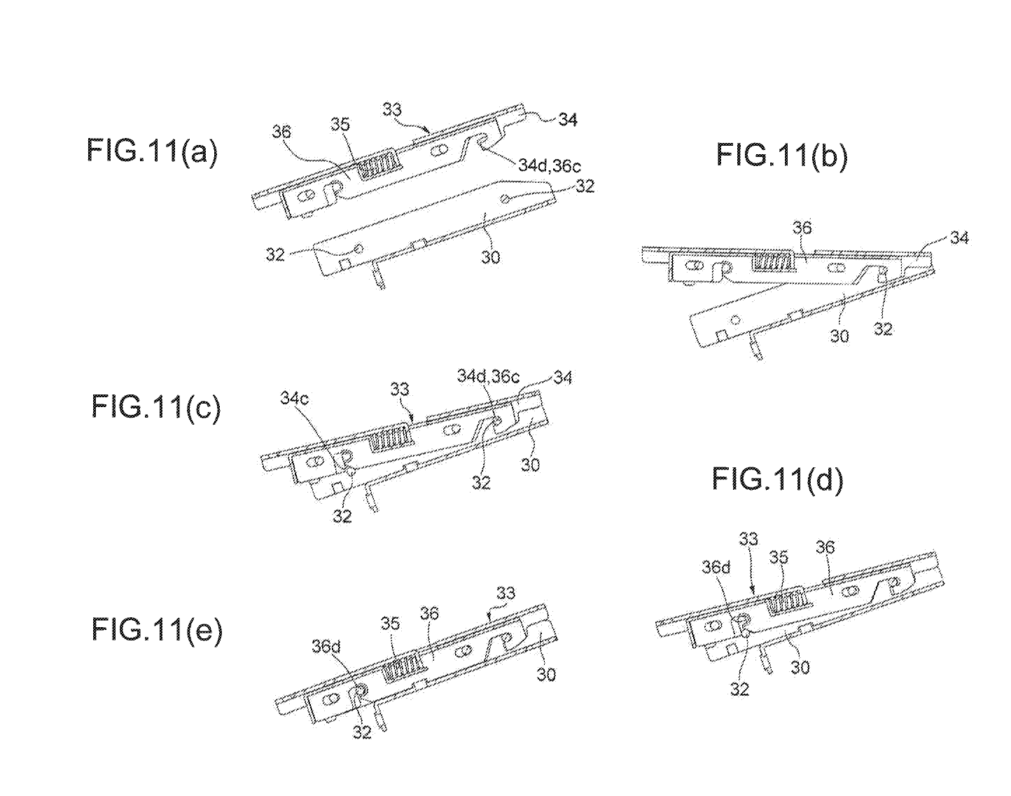

FIG. 10 is an exploded view of a door side mounting part 33. In a door plate 34, a lever 36 is inserted via a mounting spring 35, and the lever 36 is biased to the right in FIG. 10 by the mounting spring 35. The door plate 34 has two door side stepped pin holes 34a formed therein and the lever 36 has two lever mounting long holes 36a formed therein. Two door side stepped pins 37 are made to pass through the door side stepped pin holes 34a and the lever mounting long holes 36a, respectively, so that the lever 36 can slide until the door side stepped pins 37 abut to the lever mounting long holes 36a (see FIG. 11(a)). The door plate 34 and the lever 36 form the door side mounting part 3 (see FIG. 6). The door plate 34 is mounted on the door 2 via a door mounting surface 34e.

Next description is made, with reference to FIGS. 11(a) to 11(e), about the connecting method of the mounting member 30 and the door side mounting part 33. FIG. 11(a) illustrates the mounting member 30 and the door side mounting part 33 which are not yet connected. The mounting member 30 has a stepped pin 32 formed on. The door side mounting part 33 is arranged such that the lever 36 is biased to the left by the mounting spring 35.

FIG. 11(b) illustrates a door plate hook 34d and lever hook 36c fit in the right-side stepped pin 32 of the mounting member 30. As illustrated in FIG. 10, a lever approach part 36b of the lever hook 36c on the front side is longer than an approach part 34b of the door plate hook 34d. With this structure, even when the lever 36 is biased by the mounting spring 35, the approach part 34b of the door plate hook 34d is prevented from being narrowed by the lever approach part 36b. Therefore, easy fitting is allowed.

FIG. 11(c) illustrates the door side mounting part 33 which is brought close to the mounting member 30 after the door plate hook 34d and the lever hook 36c are fit on the right-side stepped pin 32 of the mounting member 30. The left-side stepped pin 32 of the mounting member 30 is in contact with a tapered part 34c of the door plate 34.

Further, FIG. 11(d) illustrates the door side mounting part 33 which is pressed against the mounting member 30. As the lever 36 is slid to the right against the spring force of the mounting spring 35, the left-side stepped pin 32 of the mounting member 30 can be fit in the lever lock 36d thereby to be able to connect the mounting member 30 to the door side mounting part 33.

FIG. 11(e) illustrates the mounting member 30 and the door side mounting part 33 connected to each other. When the left-side stepped pin 32 of the mounting member 30 is fit in the lever lock 36d, the lever lock 36d is slid to the left by the spring force of the mounting spring 35 so that the left-side stepped pin 32 of the mounting member 30 is prevented from being disengaged from the lever lock 36d.

As described above, after the door plate hook 34d and the lever hook 36c of the upper side of the door side mounting part 33 mounted on the door 2 are fit on the stepped pins 32 of the mounting member 30, the door 2 can be easily connected to the mounting member 30 only by rotating the door 2 with use of the upper-side stepped pin 32 and there is no need to get up the door 2.

When the door 2 is removed from the mounting member 30, the lever 36 is pressed to the right so that the lever 36 and the left-side stepped pin 32 of the mounting member 30 are disengaged. Then, the door 2 is held up while the lever 36 is pressed, the lever 36 is rotated and released from the left-side stepped pin 32 of the mounting member 30 completely (see FIG. 11(b)).

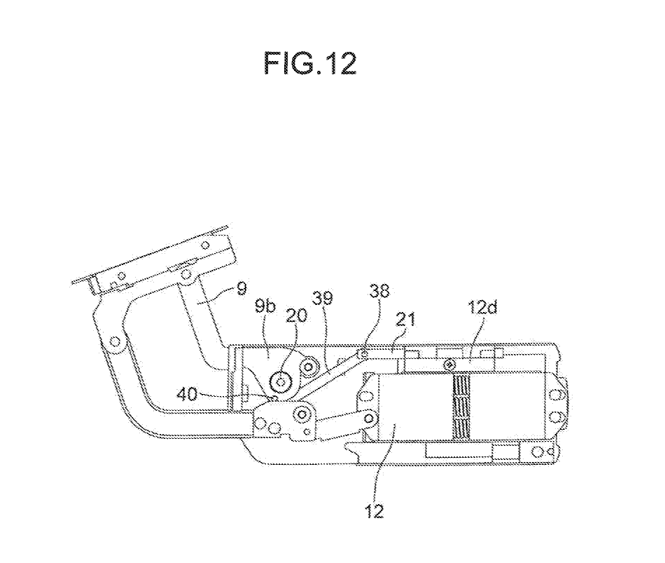

Next description is made about a door opening and closing device according to the second embodiment of the present invention. FIG. 12 illustrates the door opening and closing device according to the second embodiment.

In this embodiment, the block 12d as a fixed part of the friction damper 22 is a separate member from the runner 12 and fixed to the case 11. The friction bar 21 as a slider of the friction damper 22 is not fixed to the stopper 13 and is slidable relative to the block 12d. At the tip end on the auxiliary arm 9 side, an auxiliary axis pin 38 is provided. An end of an auxiliary link arm 39 is connected rotatable to the auxiliary axis pin 38. Besides, around the auxiliary arm axis 20, an auxiliary pivot pin 40 passes through a rotation base 9b of the auxiliary arm 9 and the auxiliary link arm 39. The auxiliary link arm 39 is connected rotatable by the auxiliary pivot pin 40. As the auxiliary arm 9 rotates by opening and closing of the door 2, the auxiliary link arm 39 slides the friction bar 21 thereby to produce a damping force.

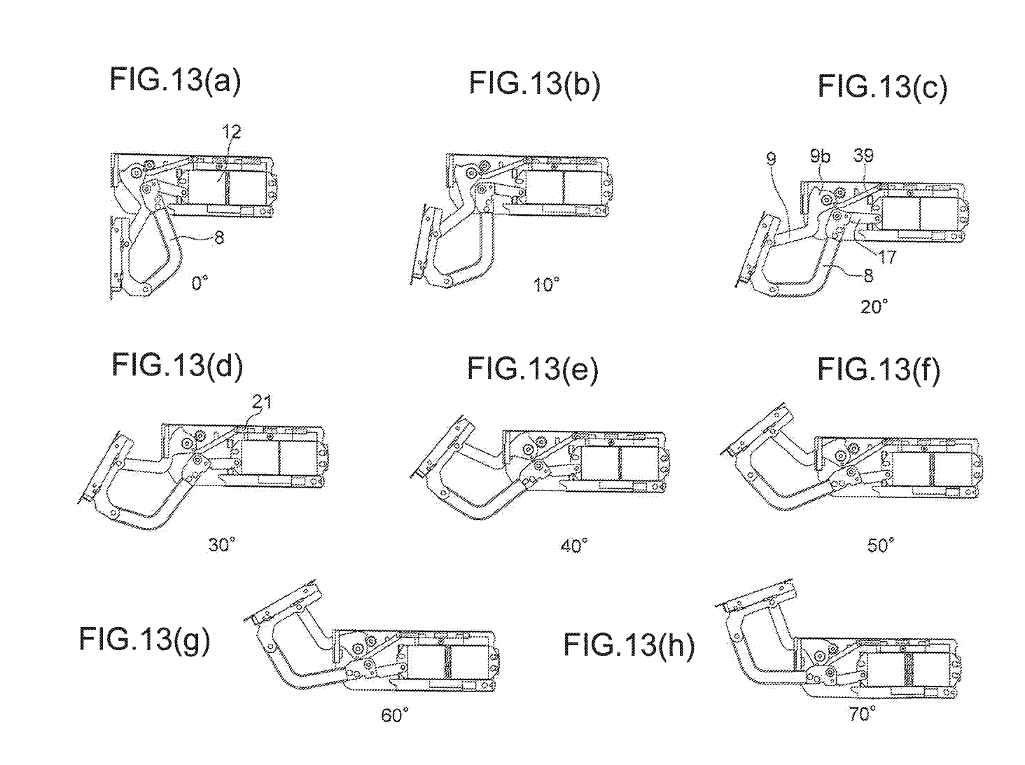

Next description is made about the relation between rotation of the arm 8 and sliding of the friction bar 21 with reference to FIGS. 13(a) to 13(h).

FIGS. 13(a) to 13(h) illustrate the door opening and closing device in which the arm 8 rotates by 10 degrees. FIG. 13(a) illustrates the door 2 closed, and the rotation angle of the arm 8 is 0 degree. In FIG. 13(c), the rotation angle of the arm 8 is 20 degrees, the friction bar 21 does not slide and there occurs no damping force. In FIG. 13(d), the rotation angle of the arm 8 is 30 degrees, the friction bar 21 starts to slide and a damping force starts to be generated. The following process is the same as that in the first embodiment until the door 2 is the open state of FIG. 13(h).

In the second embodiment, sliding of the runner 12 and the friction damper 22 is adjusted by the auxiliary link arm 39 pivoted to the rotation base 9b of the auxiliary arm 9 and the link arm 17 pivoted to the rotation base 8a of the arm 8. As the friction damper 22 and the runner 12 slide separately by opening and closing of the door 2, it is possible to set the damping force by friction and the biasing force by the compression spring 14 in an appropriate manner.

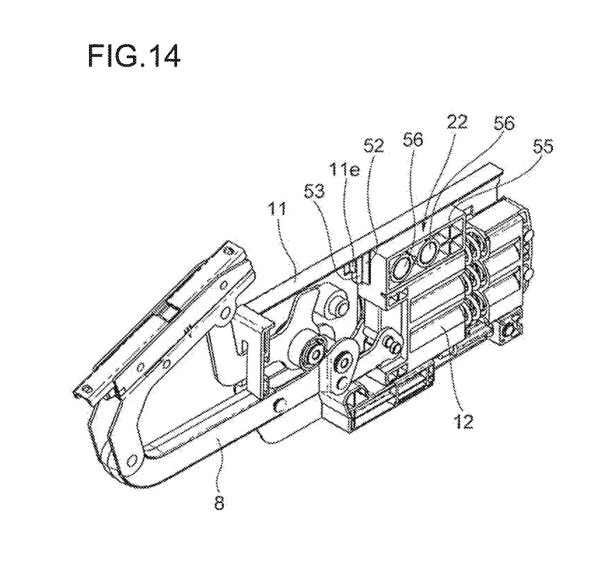

Next description is made about a door opening and closing device according to the third embodiment of the present invention. FIG. 14 is a perspective view of the door opening and closing device according to the third embodiment.

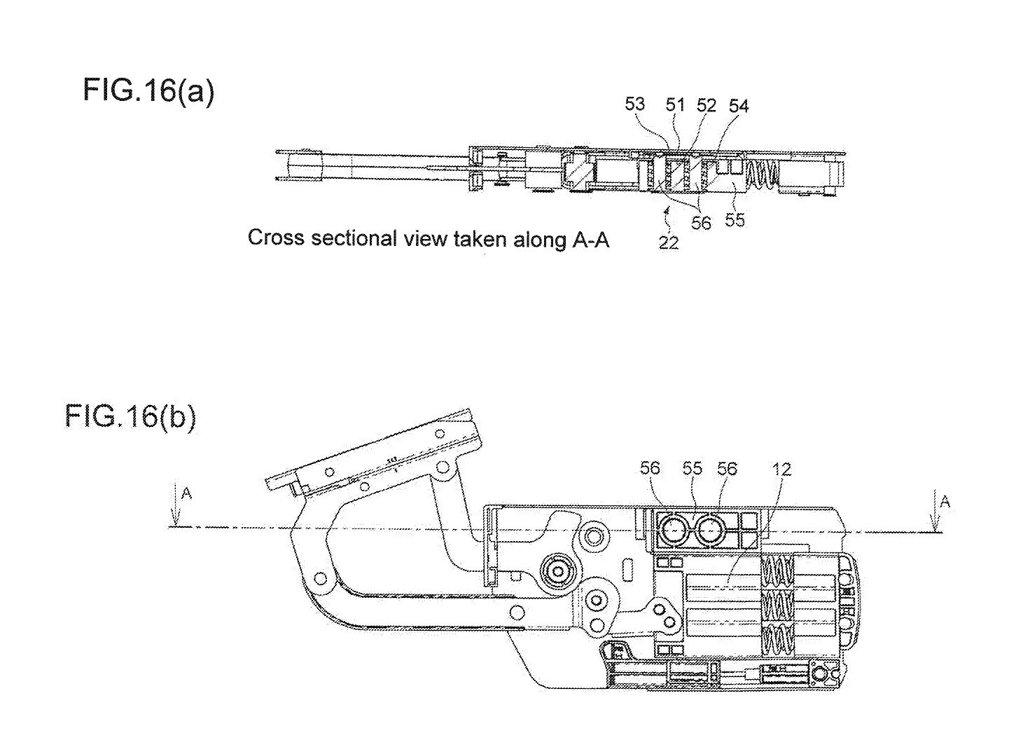

In the door opening and closing device according to the third embodiment, like the door opening and closing device in the first embodiment, the runner 12 is connected integrally to sliders 51, 52 (see FIG. 16) of the friction damper 22 so that the runner 12 and the sliders of the friction damper 22 can move linearly together. On the runner 12, a housing case 55 of rectangular shape for housing the friction damper 22 is formed integrally by resin molding. The sliders 51 and 52 of the friction damper 22 are connected to this housing case 55. A fixed plate 52 as a fixed part of the friction damper 22 is connected integrally to the case 11.

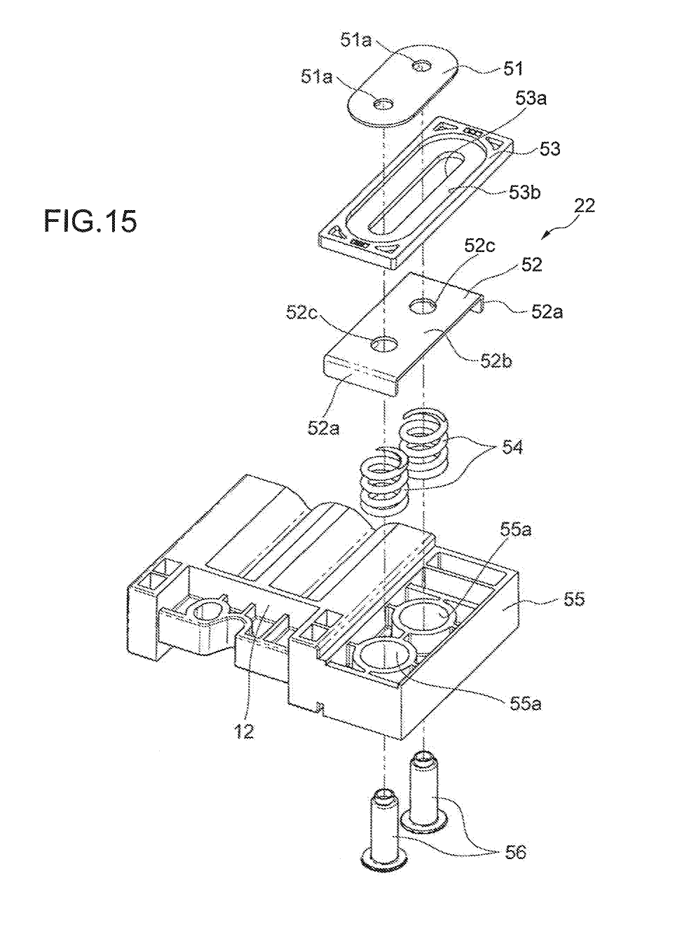

FIG. 15 is an exploded perspective view of the friction damper 22. The friction damper 22 has a fixed plate 53 as a fixed part which is fixed to the case 11 of the door opening and closing device, the sliders 51 and 52 of plate shape in a pair for sandwiching the fixed plate 53 and coil springs 54 as pressing means for pressing the slider 52 toward the fixed plate 53.

The fixed plate 53 has a rectangular shape and has, at the center, a long hole 53a extending in the moving direction of the runner 12. Around the long hole 53a, a guide groove 53b is formed which is elongated in the moving direction of the runner 12. The guide groove 53b has a square center part and semicircular ends. A bottom surface (contact part) of the guide groove 53b of the fixed plate 53 in contact with the slider 51 is flat and a back surface (contact part) of the fixed plate 53 in contact with the slider 52 is also flat. The fixed plate 53 is, for example, made of resin. The fixed plate 53 is fixed to a recess of the case 11. In the case 11, a bent piece 11e (see FIG. 14) is formed for fixing the fixed plate 53.

The slider 51 is fit slidable in the guide groove 53b of the fixed plate 53. The slider 51 has a square center part and semicircular ends. In order that the slider 51 is slidable along the guide groove 53b, the length of the slider 51 in the moving direction is shorter than the length of the guide groove 53b of the fixed plate 53. At the center part of the slider 51, a pair of holes 51a is formed for insertion of pins 56. A bottom surface (contact part) of the slider 51 in contact with the guide groove 53b is also flat. The slider 51 is, for example, made of metal.

At the opposite side of the fixed plate 53 to the slider 51, the other slider 52 of plate shape is arranged. This slider 52 has a rectangular shape and both ends 52a in the moving direction are bent at a right angle. The bent ends 52a are fit on the walls of the housing case 55 of the runner 12 (see FIG. 14). A main body 52b (contact part) of the slider 52 in contact with the fixed plate 53 is flat. At the center part of the slider 52, a pair of holes 52c is formed for insertion of the pins 56. The slider 52 is, for example, made of metal.

Between the slider 52 and the housing case 55, the coil springs 54 are provided for pressing the slider 52 toward the fixed plate 53. The friction force generated between the fixed plate 53 and the slider 52 is adjusted by an elastic force of these coil springs 54. The coil springs 54 press the slider 52 against the fixed plate 53 under a constant pressure even when the fixed plate 53 wears.

In assembling the friction damper 22, first, the coil springs 54 are inserted into cylindrical parts 55a of the housing case 55. The slider 52 is placed on the coil springs 54 and the both ends 52a of the slider 52 are fit to the walls of the housing case 55. Next, the fixed plate 53 is placed on the slider 52 and the slider 51 is fit in the guide groove 53b of the fixed plate 53. The paired pins 56 are inserted into the cylindrical parts 55a from the bottom side of the housing case 55 and the pins 56 are made to pass through the holes 51a of the slider 51 so that the two sliders 51 and 52 are integral with the housing case 55. Once the friction damper 22 is assembled, the runner 12 is mounted on the case 11. Then, the fixed plate 53 of the friction damper 22 is fixed to the case 11. In this embodiment, as the friction damper 22 is comprised of the plate-shaped sliders 51 and 52 and the fixed plate 53, it is easy to assemble the friction damper 22.

FIGS. 16(a) and 16(b) are cross sectional views of the door opening and closing device with the friction damper 22 mounted on. The sliders 51 and 52 in a pair for sandwiching the fixed plate 53 are integral with the housing case 55 by the pins 56. The sliders 51 and 52 in a pair move linearly in the moving direction of the runner 12 relative to the fixed plate 53 while sandwiching the fixed plate 53. The force of the slider 52 to press the fixed plate 53 is adjusted by the coil springs 54.

Here, the present invention is not limited to the above-described embodiments and may be embodied in various modified forms without departing from the scope of the present invention. For example, the mechanism for synchronizing rotation of the arm with liner movement of the runner is not limited to the link arm, but may be, for example, a cam mechanism. Or, it may be such a mechanism that a long hole is formed in the runner and the pivot pin of the arm is fit in the long hole of the runner.

In the above-described embodiments, the friction damper operates when the door rotates in the closing direction, as well as when the door rotates in the opening direction. However, the operation of the friction damper may be limited to either of when the door rotates in the closing direction and when the door rotates in the opening direction.

In the above-described embodiments, the arm and auxiliary arm form the four-link mechanism, however, the auxiliary may be omitted.

In the above-described embodiments, the runner is used to apply biasing forces in the opening and closing directions. However, a coil spring connected at one end to the arm may be used to apply biasing forces in the opening and closing directions directly to the arm.

The present specification is based on Japanese Patent Application No. 2010-094715 filed on Apr. 16, 2010, the entire contents of which are expressly incorporated by reference herein.

### REFERENCE NUMERALS

1 . . . door mounting member
2 . . . door
7 . . . door opening and closing device
8 . . . arm
8a . . . rotation base
11 . . . case
12 . . . runner
12b . . . slit
12c . . . through hole (hole)
12d . . . block (slider, fixed body)
14 . . . compression spring (biasing means)
17 . . . link arm
21 . . . friction bar (slider, fixed body)
22 . . . friction generating means (friction damper)
24 . . . adjustment bolt
26 . . . linear damper

1. A door opening and closing device comprising:
a case mounted on a door mounting member;
an arm which is provided rotatable on the case and rotates by opening and closing of a door;
biasing means for applying at least one of a biasing force in an opening direction and a biasing force in a closing direction to the arm; and
friction generating means having a slider which moves linearly relative to the case by opening and closing of the door and a fixed part which is fixed to the case to slide the sider, the friction generating means being provided for generating friction between the slider and the fixed part.

2. The door opening and closing device of claim 1, wherein
the door opening and closing device further comprises a runner which is provided linearly movable on the case and is biased by the biasing means to apply at least one of the biasing force in the opening direction and the biasing force in the closing direction to the arm,
the runner and the slider of the friction generating means are linearly movable together, and
a damping force of the friction generating means acts on the runner via the slider.

3. The door opening and closing device of claim 2, wherein
the slider and the fixed part of the friction generating means have respective contact parts where the slider and the fixed part are in contact with each other, and
the friction generating means further includes pressing means for pressing one of the contact parts of the slider and the fixed part toward the other.

4. The door opening and closing device of claim 2, wherein
the door opening and closing device further comprises a link arm which has one end connected rotatable to the runner and an opposite end connected rotatable to the arm around a rotation center of the arm, and
the link arm is used to synchronize rotation of the arm with linear movement of the runner.

5. The door opening and closing device of claim 2, wherein
either one of the slider and the fixed part of the friction generating means has a friction bar which is in parallel with a direction of linear movement of the runner, and
the other of the slider and the fixed part of the friction generating means has a hole for insertion of the friction bar.

6. The door opening and closing device of claim 5, wherein
the other of the slider and the fixed part of the friction generating means has a slit which is linked to the hole, and
an adjustment bolt is used to adjust a width of the slit thereby to adjust a size of the hole for insertion of the friction bar.

7. The door opening and closing device of claim 1, wherein the door opening and closing device further comprises a linear damper for braking rotation of the arm just before the arm rotates up to a fully open position or fully closed position.

8. The door opening and closing device of claim 3, wherein
the door opening and closing device further comprises a link arm which has one end connected rotatable to the runner and an opposite end connected rotatable to the arm around a rotation center of the arm, and
the link arm is used to synchronize rotation of the arm with linear movement of the runner.

9. The door opening and closing device of claim 2, wherein the door opening and closing device further comprises a linear damper for braking rotation of the arm just before the arm rotates up to a fully open position or fully closed position.

10. The door opening and closing device of claim 3, wherein the door opening and closing device further comprises a linear damper for braking rotation of the arm just before the arm rotates up to a fully open position or fully closed position.

11. The door opening and closing device of claim 4, wherein the door opening and closing device further comprises a linear damper for braking rotation of the arm just before the arm rotates up to a fully open position or fully closed position.

12. The door opening and closing device of claim 5, wherein the door opening and closing device further comprises a linear damper for braking rotation of the arm just before the arm rotates up to a fully open position or fully closed position.

13. The door opening and closing device of claim 6, wherein the door opening and closing device further comprises a linear damper for braking rotation of the arm just before the arm rotates up to a fully open position or fully closed position.

14. The door opening and closing device of claim 8, wherein the door opening and closing device further comprises a linear damper for braking rotation of the arm just before the arm rotates up to a fully open position or fully closed position.
